(19) United States
(12) Patent Application Publication
(10) Pub. No.: US 2022/0332648 A1
(43) Pub. Date: Oct. 20, 2022

(54) CURABLE COMPOSITION FOR THE MANUFACTURE, BY STEREOLITHOGRAPHY, OF GREEN PARTS OF CERAMIC OR METALLIC MATERIAL BY PHOTO-THERMAL ROUTE

(71) Applicant: S.A.S 3DCERAM-SINTO, Bonnac la Cote (FR)

(72) Inventors: Christophe CHAPUT, Le Palais Sur Vienne (FR); Richard GAIGNON, Saint-Vrain (FR); Cindy SCHICK, Le Palais Sur Vienne (FR); Stéphane SCHWEIZER, Feytiat (FR); Mariem BOUZRATI-ZERELLI, Heimsbrunn (FR); Jacques LALEVÉE, Mulhouse (FR)

(21) Appl. No.: 17/716,531

(22) Filed: Apr. 8, 2022

(30) Foreign Application Priority Data
Apr. 9, 2021 (FR) 2103673

(51) Int. Cl. C04B 35/26; C04B 22/16; C04B 22/14

(52) U.S. Cl. CPC C04B 35/26; C04B 22/16; C04B 22/14; C04B 2103/006

(57) ABSTRACT

Disclosed is a curable composition for the manufacture, by stereolithography, of a green part made of a ceramic or metallic material, the curable composition including at least one ceramic and/or metallic powder; at least one polymerizable monomer and/or oligomer; at least one initiator for the polymerization of the polymerizable monomer(s) and/or oligomer(s). The initiator(s) are selected from iodonium, sulphonium and diazonium salts and onium salts in combination with at least one amine and/or at least one phosphine to form a charge transfer complex. The initiator(s) may generate the initiation of a thermal polymerization under the exposure to at least one source of UV, visible or IR irradiation.

The present invention relates to a curable composition for manufacturing green parts of ceramic or metallic material by stereolithography, such green parts being intended to be subjected to cleaning, debinding and sintering operations in order to obtain finished ceramic or metallic parts.

Stereolithography generally comprises the following steps, for obtaining these green parts:
building, by computer-aided design, a computer model of the part to be manufactured is constructed, the sizes of the model being slightly larger than those of the part to be manufactured so as to anticipate a shrinking of the ceramic or metallic material during the manufacturing of the part; and
manufacturing the part as follows:
   forming, on a rigid support, a first layer of a photocurable composition comprising at least one ceramic or metallic material, a photocurable monomer and/or oligomer, a photoinitiator and, when appropriate, at least one of the following: a plasticizer, a solvent, a dispersant or a polymerization inhibitor;
   curing the first layer of the photocurable composition by irradiation (by laser scanning of the free surface of said layer or by using a diode projection system) according to a defined pattern based on the model for said layer, forming a first stage;
   forming, on the first stage, a second layer of the photocurable composition;
   curing the second layer of the photocurable composition, by irradiation according to a pattern defined for said layer, forming a second stage, this irradiation being performed in the same way as the first layer;
   optionally, repeating the above mentioned steps until the green part is obtained.

Then, in order to obtain the finished part as indicated above, the green part is cleaned in order to remove the uncured composition; the cleaned green part is debinded; and the cleaned and debinded green part is sintered in order to obtain the finished part.

The part may be manufactured by a paste process or by a liquid process.

In a manufacturing by a paste process, the photocurable composition is in the form of a paste while the rigid support is a working tray that supports the different layers of the part under construction as well as the paste; each of the layers is generally formed by lowering the working tray and spreading paste with a predefined thickness. A paste stock is stored in tanks that are automatically emptied of a predefined amount of paste at each layer using a piston. This creates a bead of paste to be spread over the upper layer of the part being manufactured that has been previously lowered by the working tray. Each layer is generally spread by scraping using a “scraper” blade which sweeps over the working surface of the working tray, for example by advancing in a horizontal rectilinear direction.

In the case of a manufacturing by a liquid process, the photocurable composition is in the form of a low viscosity suspension.
In a first embodiment by a liquid process, the rigid support is a tray which is lowered into a bath of the photocurable suspension in order to cover it with a layer of said suspension, said layer being then cured by irradiation as indicated above. Each of the following layers is then successively formed on this first layer by lowering the tray step by step into the bath so that the upper level of the part being formed is lowered beneath the free surface of the photocurable suspension to form the layer in question, said layer then being subject to irradiation.
In a second embodiment by a liquid process, the photocurable suspension is contained in a tank with a transparent bottom to allow irradiation, while the part being manufactured is held on a rigid support in the form of a working tray that rises step by step. Thus, we start by curing a base layer, then the working tray is raised by one step to allow the suspension to form a new layer which we then cure, whereas the operation is successively repeated for each layer.
In a third embodiment by a liquid process, the photocurable suspension is spread in a layer on a transparent film for irradiation, the film being arranged to unroll horizontally. The part is formed on a rigid working tray which is lowered in order to come into contact with the layer which is cured by irradiation through the film. We then unroll a new segment of film coated with a new photocurable layer, repeat the operation until the construction of the part is completed.

The various ceramic or metallic powders that are used in stereolithography exhibit UV light absorption behaviors at the wavelength of the UV beam used (for example 355 nm), that may vary from one to the other.

Some powders are very absorbent, such as lanthanum strontium manganite (LSM) ceramic, silicon carbide (SiC) or silver (Ag) powders, while other powders are much less absorbent, such as alumina (Al₂O₃) and zirconia (ZrO₂).

We may thus mention that the ZrO₂ powder absorbs only 8% of UV light at 355 nm, while LSM and SiC each absorb more than 90%.

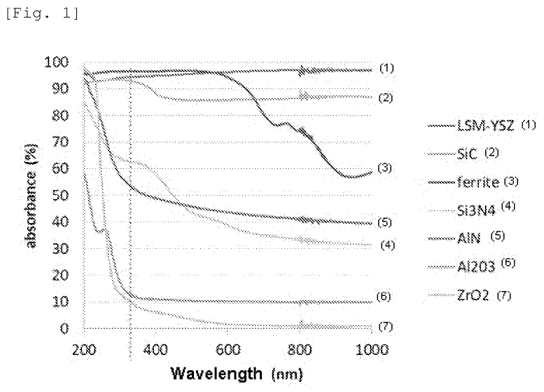

FIG. 1 shows the absorption spectra of certain ceramic/metallic powders.

In these latter cases, the light absorbed by the powder is no longer available for the photoinitiator, and the photopolymerization reaction can, therefore, no longer take place.

In other words, the lack of reactivity of certain photosensitive ceramic or metallic pastes or suspensions to UV exposure makes it difficult, if not impossible, to construct an object by UV stereolithography.

To solve this problem, the Applicant has already filed a first French patent application FR3099079 reporting the use of a thermal initiator in a ceramic or metallic paste or suspension in order to use the thermal energy released by ceramic or metallic powders during their exposure to UV-visible light as well as IR light, so as to generate the controlled initiation of the thermal polymerization.

In this case, the absorbencance of the ceramic or metallic particles at the working wavelength is therefore favorable, as the light energy absorbed by the ceramic or metallic particles is converted into heat, and as this heat is then absorbed by a thermal initiator to allow polymerization of the resin.

However, it can be pointed out that thermal initiators are generally hazardous compounds that can cause difficulties in the production, storage, transport and use of suspensions, and that ceramic suspensions tend to polymerize spontaneously over a relatively short time scale.

To overcome these drawbacks, the Applicant has developed a new initiator system allowing the polymerization of ceramic or metallic pastes or suspensions during their exposure to UV-visible light as well as a IR light: the initiator system using an onium salt or a charge-transfer complex (CTC).

Patent application US2001/036591 A1 relates to the use of iodonium salt compounds as photoinitiators. Similarly, patent application US2005/070621A1 describes photoinitiators.

Charge-transfer complexes are electron donor (ED) and electron acceptor (EA) pairs. These complexes exhibit thermal and photochemical reactivity allowing the initiation of radical polymerization in two ways:
Photochemical initiation: The CTC complex absorbs in the UV-visible to form an excited state. Electron transfer from the ED to the AE leads to cleavage of the molecule to release mainly highly reactive radicals.
Thermal initiation: When hot, the CTC complex cleaves to release free radicals. In this case, the ceramic or metallic particles absorb at the working wavelength, the absorbed light energy is then converted into heat which is then absorbed by the CTC initiator.

Since CTC complexes are more stable than conventional thermal initiators, the pot stability of suspensions is extended. In addition, the CTC complex is made up of molecules that are not listed as hazardous.

To this end, the present invention relates to a curable composition for the manufacture, by stereolithography, of a green part made of a ceramic or metallic material, said curable composition comprising:
at least one powder selected from ceramic powders and/or metallic powders;
at least one polymerizable monomer and/or at least one polymerizable oligomer;
at least one initiator for the polymerization of said polymerizable monomer(s) and/or said polymerizable oligomer(s),
   characterized by the fact that the initiator(s) is/are selected from:
iodonium, sulphonium and diazonium salts; and
onium salts in combination with at least one amine and/or at least one phosphine to form a charge-transfer complex,
   said initiator(s) being capable of generating the initiation of a thermal polymerization under the exposure to at least one irradiation source selected from UV, visible or IR irradiation sources.

The curable composition may be semi-liquid to pasty in consistency.

The ceramic powder(s) may be selected from:
oxide ceramic powders, such as lanthanum strontium manganite ceramic, lanthanum strontium manganite ceramic in mixture with yttrium-stabilized zirconia, ferrite; and
non-oxide ceramic powders, such as silicon carbide, silicon nitride and aluminum nitride.

The metal powder(s) may be selected from silver, copper, iron, tungsten and alloys thereof.

The monomer(s) and/or oligomer(s) may be selected from polyfunctional (meth)acrylates, such as diethoxylated bisphenol A dimethacrylate, 1,6-hexanediol diacrylate, 3-methyl-1,5-pentanediol diacrylate, trimethylolpropane triacrylate, and mixtures thereof.

The onium salts used in combination with at least one amine and/or at least one phosphine may be selected from iodonium, sulfonium and diazonium salts.

An iodonium salt, which may enter into the composition according to the invention, may be a diaryliodonium such as bis-(4-t-butylphenyl)-iodonium hexafluorophosphate.

A sulfonium salt, which may enter into the composition according to the invention, may be a triarylsulfonium such as triarylsulfonium hexafluoroantimonate in admixture with propylene carbonate, in particular in a proportion 50% of triarylsulfonium hexafluoroantimonate in the mixture.

The amines may be selected from primary, secondary and tertiary, aliphatic or aromatic amines. In particular, the amine may be selected from 2-[4-(dimethylamino)phenyl]ethanol, 2,2′-(4-methylphenylimino)diethanol, ethyl 4-(dimethylamino)benzoate and N-methyldiethanolamine.

The phosphines may be selected from primary, secondary and tertiary, aliphatic or aromatic phosphines. In particular, the phosphine may be selected from triphenylphosphine, 4-(diphenylphosphino)styrene, 4-(diphenylphosphino)benzoic acid, 2-(diphenylphosphino)benzoic acid 2-(diphenylphosphino)benzaldehyde, (1R,2R)-(+)-1,2-diaminocyclohexane-N,N′-bis(2-diphenylphosphino-1-naphthoyl) or (R,R)-DACH-naphthyl-Trost Ligand (a Trost ligand), bis[2-(diphenylphosphino)phenyl] ether.

The composition according to the invention may also comprise at least one plasticizer selected in particular from polyethylene glycol, dibutyl phthalate and glycerol.

The composition according to the invention may also comprise at least one dispersant selected in particular from phosphoric esters.

The composition according to the invention may comprise, relative to the total volume:
25 to 65 parts by volume of the metallic and/or ceramic powder(s);
20 to 50 parts by volume of the monomer(s) and/or oligomer(s);
0.01 to 5 parts by volume of polymerization initiator(s);
up to 25 parts by volume, in particular 5 to 25 parts by volume, of the plasticizer(s);
up to 8 parts by volume, in particular 1 to 8 parts by volume, of the dispersant(s).

The present invention also relates to a method for manufacturing, by stereolithography, a green part made of a ceramic or metallic material, method according to which layers based on a composition which is curable by polymerization and comprises a ceramic or metallic powder, depending on whether it is desired to manufacture a ceramic or metallic green part respectively, are successively cured by the said polymerization according to a pattern defined for each layer, the first layer being formed on a working tray and each other layer being formed and then cured on the preceding layer, characterized by the fact that: a curable composition as defined above is used and a thermal polymerization is carried out on each layer under the exposure to at least one source of irradiation selected from UV, visible or IR irradiation sources.

The following Examples illustrate the present invention, without limiting its scope.

### EXAMPLES 1 TO 11

Suspensions were prepared, the composition of which is given in the following Tables in % by volume of the total volume, and stereolithography tests were carried out, at the wavelengths indicated in the Tables, at the power of 2 W and at the beam diameter of 300 μm. These experiments were carried out with a stereolithography machine of the CERAMAKER type equipped with different lasers.

The results are also shown in each of Tables 1 and 2.

TABLE 1

| | Ingredients | | | | | | | Wavelength | |
|---|---|---|---|---|---|---|---|---|---|
| Example | C | M | A (amount) | | | D | P | (nm) | Result |
| 1 | 45 | 36.4 | A0 (1) | — | — | 2.6 | 15 | 355 | No reactivity |
| (comparative) | | | | | | | | | |
| 2 | 45 | 36.4 | A0 (1) | — | — | 2.6 | 15 | 1064 | No reactivity |
| (comparative) | | | | | | | | | |
| 3 | 45 | 35.2 | — | A1 (2) | A2 (0.2) | 2.6 | 15 | 1064 | Manufacturing an |
| | | | | | | | | | object several |
| | | | | | | | | | mm high |
| 4 | 45 | 35.2 | — | A1 (2) | A2 (0.2) | 2.6 | 15 | 355 | Manufacturing an |
| | | | | | | | | | object several |
| | | | | | | | | | mm high |
| 5 | 45 | 35.4 | — | A1 (2) | — | 2.6 | 15 | 355 | Manufacturing an |
| | | | | | | | | | object several |
| | | | | | | | | | mm high |
| 6 | 45 | 35.2 | — | A1 (2) | A3 (0.2) | 2.6 | 15 | 355 | Manufacturing an |
| | | | | | | | | | object several |
| | | | | | | | | | mm high |
| 7 | 45 | 35.2 | — | A1 (2) | A4 (0.2) | 2.6 | 15 | 355 | Manufacturing an |
| | | | | | | | | | object several |
| | | | | | | | | | mm high |
| 8 | 45 | 35.2 | — | A1 (2) | A5 (0.2) | 2.6 | 15 | 355 | Manufacturing an |
| | | | | | | | | | object several |
| | | | | | | | | | mm high |
| 9 | 45 | 33.9 | — | A6 (3.8) | A2 (0.2) | 2.6 | 14.5 | 355 | Manufacturing an |
| | | | | | | | | | object several |
| | | | | | | | | | mm high |

C Ceramic powder: Silicon carbide
M Monomer: Diethoxylated bisphenol A diacrylate

### A Initiators:

A0: photoinitiator sensitive to 355 nm: 2-Hydroxy-2-methyl-1-phenyl-propane-1-one
A1: SC938 Bis-(4-t-butylphenyl)-iodonium hexafluorophosphate
A2: DMAPE (2-[4-(Dimethylamino)phenyl]ethanol)
A3: 2,2′-(4-methylphenylimino)diethanol
A4: Ethyl 4-(dimethylamino)benzoate
A5: N-methyldiethanolamine
A6: mixture of triarylsulfonium hexafluoroantimonate salts in 50% of propylene carbonate
   D Dispersant: phosphoric ester Beycostat C 213
   P Plasticizer: Polyethylene glycol 300

TABLE 2

| | Ex. 10 | Ex. 11 (of |
|---|---|---|
| Ingredients | (comp.) | the invention) |
| Ferrite | 50 | 50 |
| Diethoxylated bisphenol A diacrylate | 34 | 34 |
| (Monomer) | | |
| 2-Hydroxy-2-méthyl-1-phényl-propane-1-one | 2 | 0 |
| (photoinitiator sensitive to 355 nm) | | |
| (Bis-(4-t-butylphenyl)-iodonium | 0 | 1.8 |
| hexafluorophosphate) SC938 (EA) | | |
| (2-[4-(Dimethylamino)phenyl]ethanol) | 0 | 0.2 |
| (DMAPE) (ED) | | |
| Beycostat C 213: phosphoric ester | 2.5 | 2.5 |
| (Dispersant) | | |
| Polyethylene glycol 300 (Plasticizer) | 11.5 | 11.5 |
| Wavelength (nm) | 355 | 355 |
| Power (W) | 2 | 2 |
| Beam diameter (μm) | 300 | 300 |
| | No | Manufacturing |
| | reactivity | an object |
| | | several mm |
| | | high |

1- A curable composition for the manufacture, by stereolithography, of a green part made of a material selected from a ceramic material and a metallic material, the curable composition comprising:
at least one powder selected from ceramic powders and metallic powders;
at least one polymerizable element selected from a monomer and an oligomer;
at least one initiator for the polymerization of the polymerizable element, wherein the initiator is selected from:
iodonium, sulphonium and diazonium salts; and
onium salts in combination with at least one co-initiator component selected from primary, secondary and tertiary, aliphatic or aromatic amines and primary, secondary and tertiary, aliphatic or aromatic phosphines, to form a charge-transfer complex,
the initiator being capable of generating the initiation of a thermal polymerization under the exposure to at least one irradiation source selected from UV, visible or IR irradiation sources.

2- The composition according to claim 1, wherein the ceramic powder is selected from oxide ceramic powders and non-oxide ceramic powders.

3- The composition according to claim 2, wherein the oxide ceramic powder is selected from lanthanum strontium manganite ceramic, lanthanum strontium manganite ceramic in mixture with yttrium-stabilized zirconia, ferrite.

4- The composition according to claim 2, wherein the non-oxide ceramic powder is selected from silicon carbide, silicon nitride and aluminum nitride.

5- The composition according to claim 1, wherein the metal powder is selected from silver, copper, iron, tungsten and alloys thereof.

6- The composition according to claim 1, wherein the polymerizable element is selected from polyfunctional (meth)acrylates.

7- The composition according to claim 6, wherein the polyfunctional (meth)acrylates are selected from diethoxylated bisphenol A dimethacrylate, 1,6-hexanediol diacrylate, 3-methyl-1,5-pentanediol diacrylate, trimethylolpropane triacrylate, and mixtures thereof.

8- The composition according to claim 1, wherein the iodonium salt is a diaryliodonium.

9- The composition according to claim 8, wherein the diaryliodonium is bis-(4-t-butylphenyl)-iodonium hexafluorophosphate.

10- The composition according to claim 1, wherein the sulphonium salt is a triarylsulfonium.

11- The composition according to claim 10, wherein the triarylsulfonium is triarylsulfonium hexafluoroantimonate in a mixture with propylene carbonate.

12- The composition according to claim 1, wherein the onium salts in combination with at least one co-initiator component are chosen from iodonium, sulphonium and diazonium salts.

13- The composition according to claim 12, wherein the iodonium salt is a diaryliodonium.

14- The composition according to claim 13, wherein the diaryliodonium is bis-(4-t-butylphenyl)-iodonium hexafluorophosphate.

15- The composition according to claim 12, wherein the sulphonium salt is a triarylsulfonium.

16- The composition according to claim 15, wherein the triarylsulfonium is triarylsulfonium hexafluoroantimonate in a mixture with propylene carbonate.

17- The composition according to claim 1, wherein the primary, secondary and tertiary, aliphatic or aromatic amine is selected from 2-[4-(dimethylamino)phenyl] ethanol, 2,2′-(4-methylphenylimino)diethanol, ethyl 4-(dimethylamino)benzoate and N-methyldiethanolamine.

18- The composition according to claim 1, wherein the primary, secondary and tertiary, aliphatic or aromatic phosphine is selected from triphenylphosphine, 4-(diphenylphosphino) styrene, 4-(diphenylphosphino)benzoic acid, 2-(diphenylphosphino)benzoic acid 2-(diphenylphosphino)benzaldehyde, (1R,2R)-(+)-1,2-diaminocyclohexane-N,N′-bis(2-diphenylphosphino-1-naphthoyl) or (R,R)-DACH-naphthyl-Trost Ligand, bis[2-(diphenylphosphino)phenyl] ether.

19- The composition according to claim 1, wherein the composition further comprises at least one plasticizer.

20- The composition according to claim 19, wherein the plasticizer is selected from polyethylene glycol, dibutyl phthalate and glycerol.

21- The composition according to claim 1, wherein the composition further comprises at least one dispersant.

22- The composition according to claim 21, wherein the dispersant is selected from phosphoric esters.

23- The composition according to claim 1, wherein the composition comprises, relative to the total volume:
25 to 65 parts by volume of the powder;
20 to 50 parts by volume of the polymerizable element;
0.01 to 5 parts by volume of the polymerization initiator;
up to 25 parts by volume of the plasticizer;
up to 8 parts by volume of the dispersant.

24- The composition according to claim 23, wherein the composition comprises 5 to 25 parts by volume, of the plasticizer.

25- The composition according to claim 23, wherein the composition comprises 1 to 8 parts by volume, of the dispersant.

26- A method of manufacturing, by stereolithography, a green part made of a material selected from a ceramic material and a metallic material, according to which layers based on a composition which is curable by polymerization and comprises a powder selected from a ceramic powder and a metallic powder, depending on whether it is desired to manufacture a ceramic or metallic green part respectively, are successively cured by the polymerization according to a pattern defined for each layer, the first layer being formed on a working tray and each other layer being formed and then cured on the preceding layer, wherein a curable composition as defined in claim 1 is used and wherein thermal polymerization is carried out on each layer under the action of exposure to at least one source of irradiation selected from among the UV, visible or IR irradiation sources.
